(19) United States
(12) Patent Application Publication
(10) Pub. No.: US 2005/0034340 A1
(43) Pub. Date: Feb. 17, 2005

(54) Motor vehicle decal display system

(76) Inventor: Malcolm Anton McManus Burke, Washington, DC (US)

Correspondence Address: MALCOLM A. BURKE, P.O. BOX 3538, WASHINGTON, DC, 20027, US

(21) Appl. No.: 10/950,408

(22) Filed: Sep. 28, 2004

Related U.S. Application Data
(63) Continuation-in-part of application No. 10/615,066, filed on Jul. 9, 2003.

(51) Int. Cl. G09F 7/00

(52) U.S. Cl. 40/591

(57) ABSTRACT

The present invention provides a method and means for activating, controlling, and managing the display of decals, stickers, labels, placards, automatic toll paying devices, or similar items through the use of actuating decal plates that may be programmed to be exposed dependent on a motor vehicle's operating status, at the discretion of the motor vehicle operator, or based upon the reception of external or internal activating signals such as location based devises (ie: GPS, cellular, or radio tranmissions). The motor vehicle decal display system will comprise single or multiple decal display plates, decal display plate housing(s), and button(s), switch(es) or other means of manual or sensate activation, whereby decals may be displayed depending on the nature of the vehicles operation, the commands of the operator, or other stimuli.

### CROSS REFERENCE TO RELATED APPLICATION

This application is a continuation application and applicant hereby claims the benefit of application Ser. No. 10/615,066, filed Jul. 09, 2003, entitled “Motor vehicle decal display system” which is incorporated by reference herein in its entirety.

### STATEMENT REGARDING FEDERALLY SPONSORED RESEARCH OR DEVELOPMENT

NOT APPLICABLE

### REFERENCE TO SEQUENCE LISTING, ETC.

NOT APPLICABLE

### BACKGROUND OF THE INVENTION

The present invention relates to a device for the display of decals, stickers, labels, placards, automatic toll paying devices, remote control garage door openers, or other like items so they are visible through the windows of a motor vehicle and accessible from the within the passenger compartment of the motor vehicle. More particularly, the present invention relates to an apparatus and means of activating, controlling, and managing the display of said decals, stickers, placards, or similar items affixed to decal display plates, so that they may be exposed when the car is parked, and removed from view when the motor vehicle is being operated, vice-versa, or so that the display of said decals, stickers, labels, placards, or similar items may be made depending on other operating status of the motor vehicle, at the motor vehicle operator's discretion, or by reception of activating signals. Additionally, the present invention allows for the easy removal and/or replacement of said decals, stickers, labels, placards, or similar items, by means of removable decal display plates.

It is common for federal, state, municipal, and local governments, as well as clubs, residential associations, private beaches, parking lots, schools, businesses, or other organizations or entities to require the display of certain decals, stickers, labels, placards, or similar items in the windows of motor vehicles, particularly automobiles, to indicate the particular automobile owner or operator's compliance with registration, inspection, residency, membership, affiliation, enrollment, or other obligations, or to otherwise indiacte the particular status of the motor vehicle or the owner or operator thereof pertinent to the particular authority or organization. Present means and methods of displaying these decals, stickers, labels, placards, or similar items, provides that the decals, stickers, labels, placards, or similar items be affixed or placed directly on the interior or exterior surface of the windshield glass, or the glass of certain other windows of the motor vehicle, or to the forward-facing portion of the rear view mirror.

There are inherent disadvantages to a means and method of decal, sticker, label, placard, or similar item display that does not allow for exposure of said decals, stickers, labels, placards, or similar items at the discretion of the motor vehicle operator, or automatically, given the particular nature of the motor vehicle's operation. Specifically, the prior art creates a situation in which the operator of a motor vehicle, upon the windows of which have been affixed or placed certain decals, stickers, labels, placards, or similar items, has a reduced field of vision through said windows. As a particular motor vehicle may have multiple decals, stickers, labels, placards, or similar items affixed or displayed to its windows, the field of vision of that motor vehicle's operator may be significantly compromised. This compromised field of vision may not have been accounted for by the designer of said motor vehicle, and jeoprardizes the operator's ability to operate the motor vehicle in the safest manner possible. Moreover, by not being able to direct the display of certain decals, stickers, labels, placards, or similar items, the motor vehicle operator may be disclosing information to passersby that he or she would rather keep confidential, and, if affixed to the exterior of a motor vehicle's window, the decal, sticker, label, placard, or similar items is vulnerable to theft or mutilation. Additionally, as time passes and replacement decals are issued by various authorities or organizations, it becomes necessary to remove and/or replace the decals, stickers, labels, placards, or similar items affixed to the windows. At times this may be very difficult due to the awkward positioning of the decals, stickers, labels, placards, or similar items, as well as to the condition of the adhesive which affixed the decal, as it has been effected by sunlight and other elements affecting the window. Finally, the prior art creates a situation where the operator of a motor vehicle cannot transfer decals, stickers, labels, placards, or similar items which have been affixed to a window from one motor vehicle to another. (For example, in cases where a motor vehicle must be repaired, and the operator uses another, temporary motor vehicle, it would be advantageous to transfer a parking decal to the temporary motor vehicle.) It is to these failures of the prior art, among others, to which the present invention is drawn.

### BRIEF SUMMARY OF THE INVENTION

The present invention provides a system for activating, controlling, and managing the display of decals, stickers, labels, placards, or similar items through the windows of a motor vehicle. The motor vehicle decal display system will comprise a single, or multiple decal display plates upon which decals, stickers, labels, placards, or similar items may be affixed and housed within single or multiple housing units. One or more of these decal display plates and concomitant housing units may be designed to accept an automatic toll-paying device. The location of these decal plate housing units will be within the interior of the motor vehicle and near those areas of the windows of a motor vehicle which have traditionally been used to display decals, stickers, labels, placards, or similar items (e.g.: the edges of the front windshield, particularly the corners thereof; the edges of the rear window, particularly the corners thereof; the forward-facing surface of the rear view mirror; and such other places as may be deemed appropriate for display of decals, stickers, labels, placards, or similar items). These decal display plates may be retracted into the housing units, which in turn would be recessed in that space between the interior and exterior body panels of the motor vehicle, or below the surface of the vehicle's dashboard, thereby concealing display of any decals affixed thereto. The motor vehicle decal display system will also comprise a single or multiple switches, buttons or other means of manual or sensate activation, whereby the position of the decal plates (either exposed or retracted) can be managed and thereby the display of certain decals, stickers, labels, placards, or similar items through the windows of a motor vehicle may be engaged as directed by the operator, or may be programmed to be displayed automatically given the particular nature of the vehicle's operation. Additionally, the motor vehicle decal display system may include the circuitry, receivers, and other elements necessary to allow the automatic exposure and retraction of the decal display plates in response to outside stimuli (such as transmissions from radio transmitters, blue-tooth technology, or other communications devices), or based on the vehicle's position on the earth's surface as determined by signals from a global positioning system (“GPS”) device. Additionally, the motor vehicle decal display system will comprise a means of removing and/or replacing the decal plates, to allow for easier removal of the decals affixed thereto, or for the replacement or transfer of the decal display plates altogether.

The switch or other means of activation and the circuitry connected thereto will allow for the programming of a particular decal plate in a multitude of ways, including: 1) to always be retracted during operation of the motor vehicle, or in some other nature or manner of operation, while automatically being extended or exposed when the motor vehicle is engaged in the “parked” gear, or in some other nature or manner of operation, (i.e.: while the car is unoccupied, the key is not inserted in the ignition, the engine is not running, the vehicle's alarm is armed, etc, etc.), (herinafter termed, for ease of reference, “diplayed when parked”); and 2), to always be retracted while the motor vehicle is engaged in the “parked” gear, or in some other nature or manner of operation while automatically exposed during operation of the motor vehicle (i.e.: while the car is occupied, the key is inserted in the ignition, the engine is running, the vehicle's alarm is disarmed, etc, etc.), (herinafter termed, for ease of reference, “diplayed when driving”). The advantage to this invention is that it allows for the display of certain decals, stickers, labels, placards, or similar items through the windows of a motor vehicle, only when the viewing thereof is possible, warranted, or desired by the operator, (displayed when parked versus displayed when driving), and thereby the operator's field of vision through the windows of the motor vehicle will not be needlessly impaired.

The activation of the decal display plate may also be activated automatically by internal or external transmissions or influences on the motor vehicle. For example, when the motor vehicle approches a parking garage for which it has a parking pass or decal, a transmitter at the garage may activate, through the use of blue-tooth, radio or cellular frequency, or other signal transmission; the exposure of the decal display plate upon which the parking pass is affixed, and thereby expose the parking pass. Such a result may be accomplished by the inclusion of a reciever that would detect the outside stimuli and activate the circuitry to effect the decal display plates. Similar activation from the exterior of the motor vehicle would be advantageous for use of automatic toll-paying devices such as “SpeedPass” and “EZPass” in conjunction with the present invention. Additionally, the decal display plate system could be designed to receive signals from a GPS device and therby be programmed to expose and retract certain decal display plates depending upon the motor vehicle's position on the earth's surface.

Previously, the operator of a motor vehicle could not manage the display of decals, stickers, labels, placards, or similar items, as described above. The present invention allows for this management, makes operation of the motor vehicle safer, limits discosure of certain information, and makes replacement/removal of decals, stickers, labels, placards, or similar items easier.

### BRIEF DESCRIPTION OF THE SEVERAL DRAWINGS

FIG. 1 is a perspective view of one housing unit and decal display plate of the decal display system according to the present invention.

FIG. 2 is an overhead perspective view of a motor vehicle.

FIG. 3 is a cross sectional view of a motor vehicle taken along the line III-III of FIG. 2.

FIG. 4 is perspective view of one housing unit of the decal display system with interior portions and elements represented by hidden lines.

### DETAILED DESCRIPTION OF THE INVENTION

This invention consists of a plurality of decal display plates 12, housed within a plurality of decal display plate housing units 13, the operation of which may be managed by a plurality of buttons, switches, 31 or other means of sensate activation of a plurality of electric motors 21 within the housing units 13, and the circuitry 22 to so control the activation and exposure or retraction of decal display plates 12, from within a plurality of decal display plate housings 13, in a manner consistent with the operator's discretion. This invention is an improvement to the areas immediatetly surrounding the windshield 14 and other windows of the motor vehicle 15.

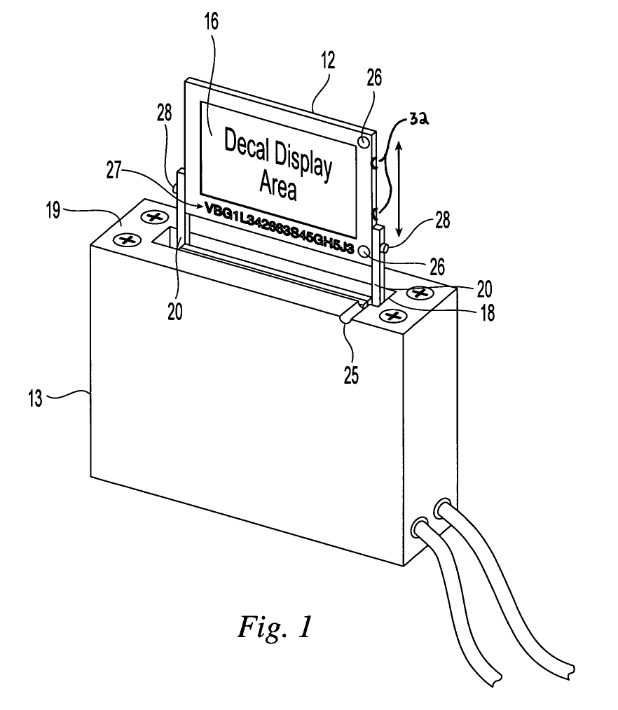

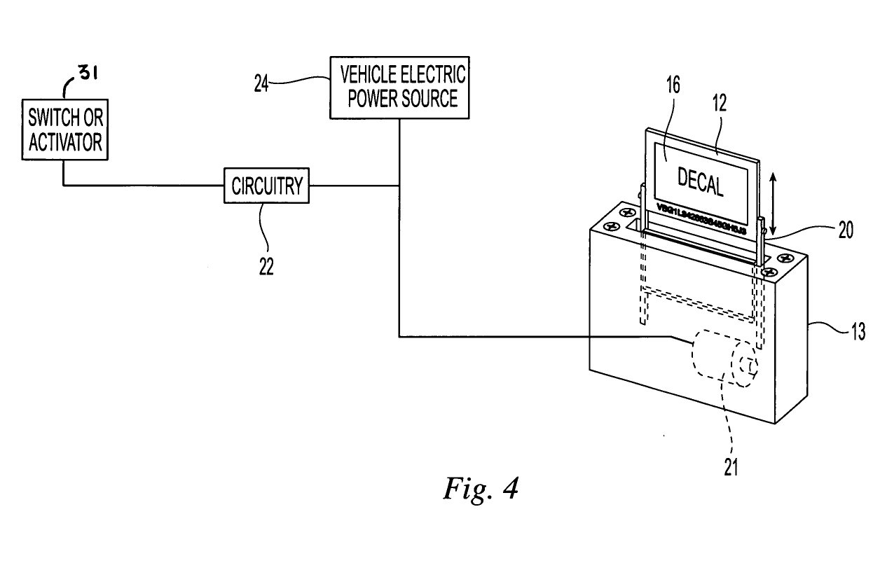

As FIGS. 1 and 4 illustrate, the best mode of design and composition for the individual decal display plates 12 is that of a clear plastic or safety glass plate, of minimal thickness (approximating ⅛^{th} of an inch thick, and measuring approximately six (6) inches wide by four (4) inches long, with a decal display area 16 of approximately five (5) inches by three (3) inches. Also, the decal display plate 12 may be inscribed with the vehicle identification number (“VIN”) of its host vehicle 27 so as to frustrate attempts to transfer decals, the issuers of which desire to be used on a particular vehicle. Within each housing 13 could be stacked several decal plates 12, to allow for the display of different decals which need not be displayed simultaneously, or a single decal plate 12. The mechanism by which the selected decal plates 12 may be retracted into, or exposed from, the housing 13 may consist of a pair of rails or tracks 20 along the interior edge 18 of the opening on the top surface 19 of the housing unit 13, within which the decal plate 12 is seated. When activated, the decal plates 12 are exposed by activation of an electrical motor or device 21, connected to the vehicle's electric power source 24 that pushes the decal plate 12 from the housing 13. This is most easily performed by connecting the decal plate housing 13, and the device that exposes the decal plate 21 to the vehicle's electrical power supply 24 through circuitry 22 which may be completed by the activation of the above-described button or switch. Additionally, the housing unit 13 provides for manual over-ride operation, through the inclusion of a small opening 25 in the housing 13 and in the decal display plate 26, into which could be placed an article, like a pen or key to-push the tracks 20, and thereby expose or retract the decal plate 12. Finally, the tracks 20 and decal display plate 12 provide a means of removing, and replacing decal plates 12. This is readily accomplished by the inclusion of a plurality of spring loaded ball bearings 28 within the tracks 20 which would seat within depressions 32 incorporated within the corresponding sides of the decal display plates 12.

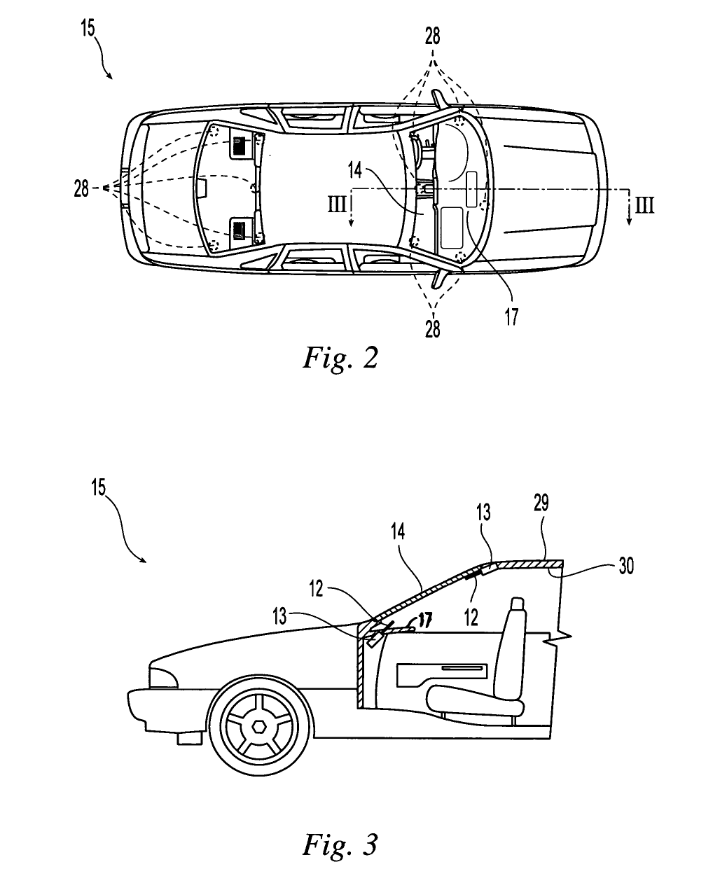

As FIGS. 2 and 3 illustrate, multiple housing units 13 may be installed at the the perimeter of the windshield 14 and near the dashboard 17, and other locations 28 near the other windows of the motor vehicle 15, allowing the operator to display decals at particular locations, as presecribed by the pertinent authorities, or issuers of the decals, as the case may be. (For example, in Washington D.C., motor vehicle operators are directed to place their vehicle registration decal in the lower left-hand corner of the driver's side of the windshield when viewed from the interior of the motor vehicle.) Further, when exposed or extended from the decal display plate housing 13, the decal display plates 12 would be oriented in such a manner as to prevent their vibration against, or contact with, the motor vehicle's 15 windows or windshield 14.

As FIG. 3 illustrates, the best mode of use of the decal plate housing(s) 13 is for the placement thereof beneath the surface of the dashboard 17 of the motor vehicle 15, with a non-obtrusive and discrete appearance. The decal plate 12 may also be housed within this decal plate housing 13 recessed between the interior and exterior body panels of the motor vehicle. (For example, between the exterior roof panel 29 of the motor vehicle 15 and the interior ceiling panel 30 of the motor vehicle 15 for the display of decals through the windshield 14.)

While the invention has been described with particular reference to a best mode, it will be understood by those skilled in the art that various changes may be made and equivalents may be substituted for elements of the best mode without departing from the invention. For example, many modifications may be made to adapt a particular situation and material to a teaching of the invention without departing from the essential teachings of the present invention.

As is evident from the foregoing description, certain aspects of the invention are not limited to the particular details of the examples illustrated, and it is therefore contemplated that other modifications and applications will occur to those skilled the art. For example, items other than decals, stickers, labels, placards, and toll paying devices may affixed to the decal plates. Also, the exact means of activation and operation of the decal plates may be accomplished in a multitude of ways including, but not limited to, location based technologies (i.e., GPS, blue-tooth or radio transmission) or sensate activation (i.e., voice recognition). It is accordingly intended that the claims shall cover all such modifications and applications as do not depart from the true spirit and scope of the invention.

1. A decal display plate composed of plastic, safety glass plate, or other material, approximately ⅛^{th} of an inch thick, and measuring approximately six (6) inches wide by approximately four (4) inches long, with a decal display area of approximately five (5) inches by approximately three (3) inches, along the sides of which are a plurality of depressions to accommodate spring-loaded ball bearings that secure the decal display plate to tracks within a decal display plate housing, and through the front surface of which are a plurality of holes through which a small article could be inserted, and upon the front surface of which is an area which may be etched or embossed with a vehicle identification number or other data.

2. A decal display system within a motor vehicle comprising:
a plurality of decal display plates;
a plurality of decal display plate housing units containing a retainer mechanism comprising tracks into which the deal display plate may be inserted and within which are spring elements which provide sufficient spring force to maintain engagement of ball bearings within accommodating depressions along the edges of the decal display plate, and which are connected to an electric motor which, when activated, causes the tracks to articulate in such a manner as to expose the decal display plate from within the housing unit through an opening on the top edge of the housing unit, or when activated in another manner to cause the tracks to retract into the housing unit, thereby retracting the decal display plate through the aforementioned opening and concealing the decal display plate from view, and
a means for managing the exposure of said decal display plates from within said housing units comprising a selector switch associated with circuitry, the motor vehicle's electric power source, and the electric motor within the decal display plate housing unit wherein said selector switch may be adapted in one position to automatically activate the electrical motor connected to the motor vehicle's electric power supply, and extend a particular decal display plate whenever the motor vehicle is in the “park” gear, or in some other nature or manner of operation (e.g.: while the car is unoccupied, when the key is not inserted into the ignition, when the engine is not running, or when the motor vehicle's alarm has been armed), and which may be adapted into another position to extend the decal display plate from the housing when the motor vehicle is in an “operating” gear (i.e., a forward gear, reverse, or neutral), or in some other nature or manner of operation (e.g., while the car is occupied, when the key is inserted into the ignition, when the engine is running).

3. A decal display system of claim 2 wherein said selector switch is adapted with a receiver to extend and retract the decal display plate upon the receipt of signals or transmissions from within or outside the motor vehicle (e.g. when the motor vehicle is located within a particular area, or areas, on the earth's surface, and as pre-programmed by the vehicle operator or owner utilizing data received from a global position satellite (“GPS”) unit; or when the motor vehicle is in close proximity to a devise emitting radio, cellular, blue-tooth or other signals which activate the selector switch.)

4. A decal display system of claim 3 wherein the opening on the top edge of the housing unit is adapted to allow for passage of a decal display plate upon which an article thicker than a decal has been affixed, (i.e., such devices as automatic toll paying devices like “EZPass” and “Speed Pass” units, or a remote control garage door opener.)
